(19) United States
(12) Patent Application Publication
(10) Pub. No.: US 2026/0161331 A1
(43) Pub. Date: Jun. 11, 2026

(54) IMAGE FORMING APPARATUS, IMAGE FORMING SYSTEM, CONTROL METHOD FOR IMAGE FORMING SYSTEM, AND STORAGE MEDIUM

(71) Applicant: CANON KABUSHIKI KAISHA, Tokyo (JP)

(72) Inventor: HIDEKAZU MOROOKA, Kanagawa (JP)

(21) Appl. No.: 19/372,683

(22) Filed: Oct. 29, 2025

(30) Foreign Application Priority Data
Oct. 31, 2024 (JP) 2024-192412

(51) Int. Cl. G06F 3/12

(52) U.S. Cl. CPC G06F 3/1204; G06F 3/1225; G06F 3/1231; G06F 3/1232; G06F 3/1236; G06F 3/1255; G06F 3/1288

(57) ABSTRACT

The image forming apparatus that can communicate with a cloud printing system that provides a cloud printing service, the image forming apparatus comprising: one or more first memory devices that store a set of instructions; and one or more first processors that execute the set of instructions to: connect to a communication network, and set identification information that can identify the image forming apparatus, wherein when first information indicating that the image forming apparatus has been registered in the cloud printing service is received, identification information for the cloud printing service for performing an image formation setting for the cloud printing service is set as identification information of the image forming apparatus, and the identification information for the cloud printing service having been set is transmitted toward an information processing terminal.

### BACKGROUND

### Field of the Technology

The present disclosure relates to an image forming apparatus, an image forming system, a control method for the image forming system, and a storage medium.

### Description of the Related Art

In recent years, a general-purpose printer driver (local printer driver) that directly communicates with a printer using a standard protocol of the printing industry such as the Internet Printing Protocol (IPP) is known. The local printer driver can communicate with printers of a plurality of printer vendors. Therefore, use of the local printer driver enables a print job to be transmitted to a printer even when the user does not install a vendor-specific printer driver.

Furthermore, printing using a cloud printing service is also known. In the cloud printing service, a printer driver (cloud printing compatible driver) for the cloud printing service is installed into an information processing apparatus. Then, the information processing apparatus generates a print job using the cloud printing compatible driver, and transmits the print job to a cloud printing system that provides the cloud printing service. Then, the cloud printing system transmits the print job to a printer, and the printer executes printing.

The local printer driver and the cloud printing compatible driver described above handle print jobs printed by printers of various vendors, and therefore there are limitations on print settable items and functions. Therefore, as Japanese Patent Laid-Open No. 2021-124791, a method for acquiring a print setting extension app associated with printer identification information (e.g., HardWareID, hereinafter also referred to as HWID) and extending a print queue associated with a printer driver is considered. This can realize display of a vendor-proprietary print setting user interface (UI) and a print job editing function.

The HWID used when acquiring the print setting extension app does not include information on whether or not the image forming apparatus has been connected to the cloud printing service. Therefore, it is difficult to acquire the print setting extension app for cloud printing by the above method. Therefore, first, the print setting extension app is installed, and after the install, work for cloud connection is performed.

### SUMMARY

The present disclosure enables realization of a novel mechanism that can easily introduce a print setting for a cloud printing service.

One aspect of the present disclosure provides an image forming apparatus that can communicate with a cloud printing system that provides a cloud printing service, the image forming apparatus comprising: one or more first memory devices that store a set of instructions; and one or more first processors that execute the set of instructions to: connect to a communication network, and set identification information that can identify the image forming apparatus, wherein when first information indicating that the image forming apparatus has been registered in the cloud printing service is received, identification information for the cloud printing service for performing an image formation setting for the cloud printing service is set as identification information of the image forming apparatus, and the identification information for the cloud printing service having been set is transmitted toward an information processing terminal.

Another aspect of the present disclosure provides a control method for an image forming system including an image forming apparatus that can communicate with a cloud printing system that provides a cloud printing service, and an information processing terminal, the control method comprising: in the image forming apparatus, connecting to a communication network and receiving information indicating that the image forming apparatus has been registered in the cloud printing service, setting, as identification information of the image forming apparatus, identification information for the cloud printing service for performing an image formation setting for the cloud printing service, and transmitting the identification information for the cloud printing service having been set toward the information processing terminal, and in the information processing terminal, receiving the identification information for the cloud printing service having been transmitted from the image forming apparatus, receiving an application for performing the image formation setting for the cloud printing service by using the identification information for the cloud printing service, and performing the image formation setting for the cloud printing service by using the application.

Still another aspect of the present disclosure provides a non-transitory computer-readable storage medium storing a computer program for causing a computer to execute each step in a control method for an image forming apparatus that can communicate with a cloud printing system that provides a cloud printing service, the control method including connecting to a communication network and receiving information indicating that the image forming apparatus has been registered in the cloud printing service, setting, as identification information of the image forming apparatus, identification information for the cloud printing service for performing an image formation setting for the cloud printing service, and transmitting the identification information for the cloud printing service having been set toward an information processing terminal.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a schematic view of an image forming system according to one embodiment.

FIGS. 2A to 2C are hardware configuration diagrams of respective apparatuses according to one embodiment.

FIG. 2D is a software block diagram of the image forming system according to one embodiment.

FIGS. 3A and 3B are flowcharts showing a processing procedure of the image forming system according to one embodiment.

FIGS. 4A and 4B are flowcharts showing a processing procedure of the image forming system according to one embodiment.

FIG. 5 is a flowchart showing a processing procedure of the image forming system according to one embodiment.

FIG. 6 is a flowchart showing a processing procedure of the image forming system according to one embodiment.

FIG. 7 is a view illustrating a display screen of a client terminal according to one embodiment.

FIGS. 8A and 8B are flowcharts showing a processing procedure of the image forming system according to one embodiment.

FIG. 9 is a flowchart showing a processing procedure of an image forming apparatus according to one embodiment.

FIG. 10 is a view illustrating a display screen of a client terminal according to one embodiment.

FIG. 11 is a view illustrating an API according to one embodiment.

FIG. 12 is a flowchart showing a processing procedure of the image forming system according to one embodiment.

FIG. 13 is a flowchart showing a processing procedure of the image forming system according to one embodiment.

FIG. 14 is a view illustrating an HWID according to one embodiment.

FIG. 15 is a view illustrating a search packet according to one embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

In the present description, the term “image forming apparatus” broadly includes an apparatus that forms (records) an image on a recording material (recording medium), such as a single function printer, a copying machine, a multifunction peripheral, and a commercial printing machine. The image forming apparatus may be a system (image forming system) in which an image forming apparatus main body that forms an image on a recording material and equipment such as a sheet processing apparatus and a paper feeding apparatus are connected.

### First Embodiment

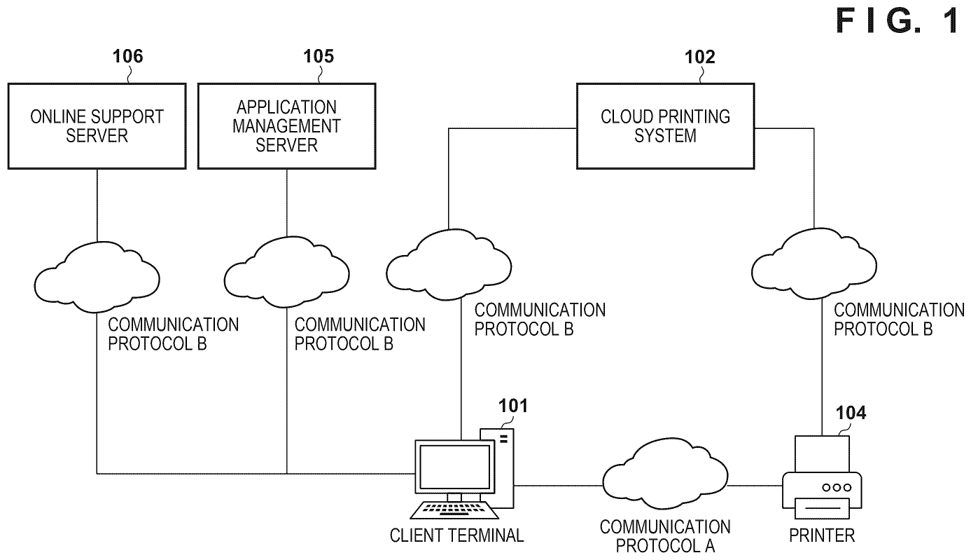

An outline of an image forming system 100 according to an embodiment will be described with reference to FIG. 1. The image forming system 100 is configured to include a client terminal 101, a cloud printing system 102, a printer 104, an application management server 105, and an online support server 106. Note that the client terminal 101 is an example of an “information processing terminal”, and the printer 104 is an example of an “image forming apparatus”.

The client terminal 101 and the printer 104 are connected via a network, and a communication protocol A is used for the communication. The printer 104 has a function of cooperating with the cloud printing system 102 described later, and is a printer compatible with a cloud printing service provided by the cloud printing system 102. Note that the communication protocol A is a dedicated protocol for transmitting and receiving data mainly between the client terminal 101 and the printer 104, and supports functions such as print job transfer and printer state confirmation.

The client terminal 101 and the printer 104 are each connected to the cloud printing system 102 via a network. A communication protocol B is used for this communication. The communication protocol B is a general protocol (e.g., HTTP, HTTPS, or the like) for transmitting and receiving cloud services and data on the Internet, for example. This protocol realizes secure high-speed communication between the client terminal 101 and the cloud printing system 102 and between the printer 104 and the cloud printing system 102.

The client terminal 101 is also connected to the application management server 105 and the online support server 106 via a network, and the communication protocol B is used for the communication. This enables the client terminal 101 to receive application update and technical support online. When communicating with another server via the Internet, the client terminal 101 can perform secure and efficient data transfer by the communication protocol B. The communication protocol A and the communication protocol B are protocols suitable for different purposes and uses, and the network configuration in the image forming system functions efficiently by being selectively used according to each role.

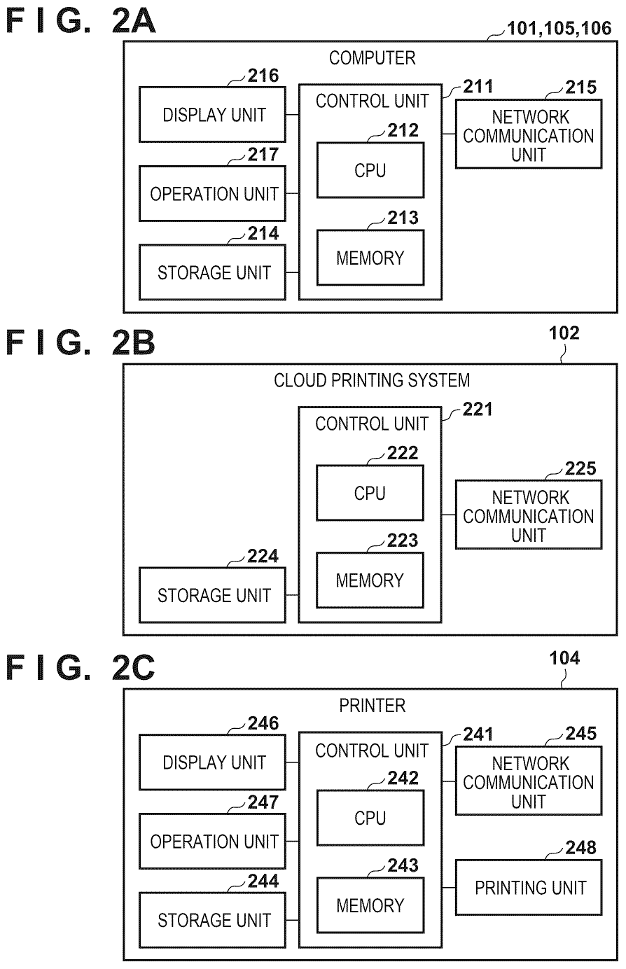

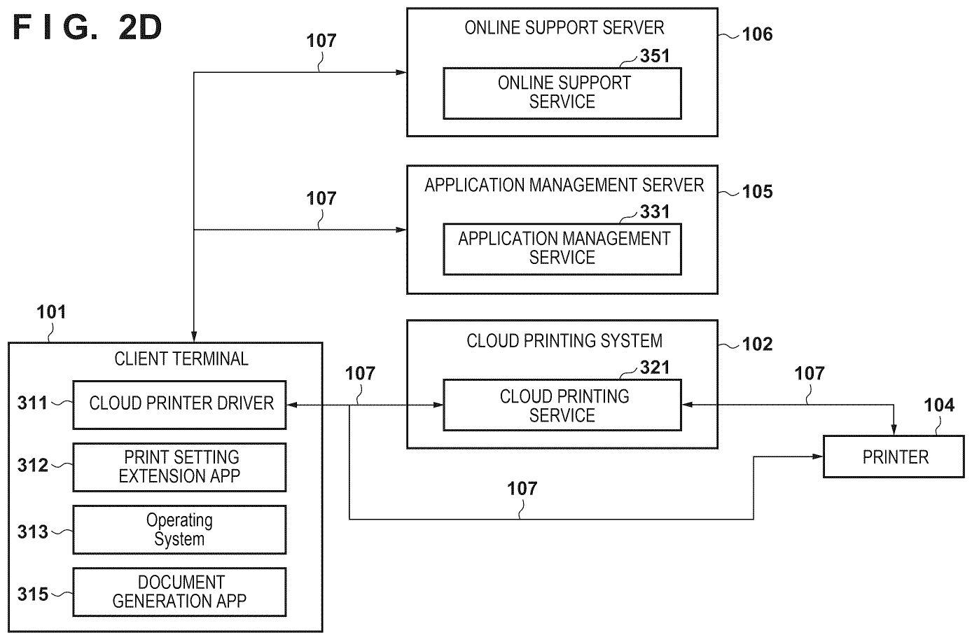

Next, the hardware configuration of each apparatus constituting the image forming system 100 will be described with reference to FIGS. 2A to 2C. FIG. 2A illustrates the hardware configuration of the client terminal 101. The client terminal 101 is, for example, a PC, a tablet, a smartphone, or the like, and is directly operated by the user. The client terminal 101 is configured to include a display unit 216, an operation unit 217, a storage unit 214, a control unit 211, and a network communication unit 215.

The storage unit 214 is a nonvolatile storage apparatus such as a hard disk or an SSD, and can store and rewrite digital data. The control unit 211 is configured to include a CPU 212 and a memory 213, and controls the entire operation of the client terminal 101. The CPU 212 loads, into the memory 213, and executes, a program stored in the storage unit 214, thereby controlling each component. In this manner, each function described later is realized. The memory 213 is a main storage memory of the CPU 212 and is used as a work area and a temporary storage area for loading various programs.

The network communication unit 215 is configured to include a communication module such as a network interface card (NIC), and communicates with the outside via a network 107 (an example of a “communication network”). The control unit 211 inputs/outputs digital data to/from an external server, a client terminal, and the like using the network communication unit 215.

The display unit 216 is configured to include an apparatus that displays visual information to the user, such as a liquid crystal display. The operation unit 217 is configured to include an apparatus that receives an input from the user by, for example, a keyboard, a mouse, or the like. Note that the client terminal 101 may include an apparatus including both functions of the display unit 216 and the operation unit 217, such as a touch panel. Note that the application management server 105 and the online support server 106 have a hardware configuration similar to that of the client terminal 101, and thus description thereof will be omitted.

FIG. 2B illustrates the hardware configuration of the cloud printing system 102. The cloud printing system 102 is configured to include a storage unit 224, a control unit 221, and a network communication unit 225. Note that the storage unit 224, the control unit 221, and the network communication unit 225 are equivalent to those included in the client terminal 101, and thus description thereof will be omitted. Note that hereinafter, the cloud printing system 102 is assumed to be one information processing apparatus including the hardware configuration illustrated in FIG. 2B, but may be configured by a plurality of information processing apparatuses, and equivalent functions may be provided.

FIG. 2C illustrates the hardware configuration of the printer 104. The printer 104 is configured to include a display unit 246, an operation unit 247, a storage unit 244, a control unit 241, a network communication unit 245, and a printing unit 248. The display unit 246 is, for example, a touch panel, an LED, or the like provided in the printer 104, and displays information to the user. The operation unit 247 is configured to include, for example, a touch panel on which the user can perform an input operation. Note that the operation unit 247 may include hardware keys such as a numeric keypad. The storage unit 244 and the control unit 241 are equivalent to those included in the client terminal 101, and thus the description thereof will be omitted.

The network communication unit 245 is configured to include a communication module and communicates with the outside via the network 107. That is, the network communication unit 245 mainly receives print data and transmits a state of the printer 104 such as an error to an external server or the like. The printing unit 248 is configured to include a structure that can execute print processing by performing a series of operations including paper feeding, printing, and paper discharging on paper prepared in a cassette or a tray. Note that the printing method is not particularly limited, and is, for example, an electrophotographic method, an inkjet method, or the like. The printing unit 248 includes a double-sided unit used at the time of paper discharging, and a finishing apparatus such as stapling and punching.

Note that as the printer 104, for example, a single function printer having only a printing function can be exemplified, but a multifunction printer (multifunction peripheral) having both a scanner function and a FAX function may be employed.

The software block of the image forming system 100 including the apparatus described above will be described with reference to FIG. 2D. In the image forming system 100, the client terminal 101, the cloud printing system 102, the application management server 105, the printer 104, and the online support server 106 as described above are connected to one another via the network 107.

Note that FIG. 2D illustrates a configuration including one client terminal 101 and one printer 104, but the number of the client terminals 101 and the number of printers 104 may be plural. The cloud printing system 102, the application management server 105, or the online support server 106 may be a server system including a plurality of information processing apparatuses. By configuring each server as a server system including a plurality of information processing apparatuses, it is possible to distribute a load to the plurality of information processing apparatuses. The cloud printing system 102, the application management server 105, or the online support server 106 may be virtually configured inside one information processing apparatus. The network 107 is, for example, a wide area network (WAN) such as the Internet, but may be a closed network such as a corporate LAN.

The client terminal 101 can execute arbitrary application software, and for example, a cloud printer driver 311, a print setting extension app 312, and a document generation app 315 are installed. The cloud printer driver 311 generates print data. The client terminal 101 transmits such print data to the cloud printing system 102 via the network 107. The print setting extension app 312 extends the print queue associated with the printer driver (an example of an “image formation setting for a cloud printing service”). The document generation app 315 is an application such as a document data creation application, a presentation material creation application, and a photo or image data display application.

The cloud printing system 102 provides a cloud printing service 321. The cloud printing service 321 receives a print instruction and print data from the outside. The cloud printing service 321 transmits this print data to a predetermined printer 104 based on the received print data. This printer 104 receives print data from the cloud printing system 102 via the network 107. Then, the printer 104 converts the print data into image data, and actually performs printing on a recording medium such as paper.

The application management server 105 provides an application management service 331 that holds and manages various applications. The application management service 331 receives identification information of an application and a download request from the client terminal 101, and transmits the application specified based on the received identification information to the client terminal 101. The online support server 106 provides an online support service 351. The online support service 351 provides the client terminal 101 with an extended set-up information file describing information for extending the function of the client terminal 101.

### Processing Example 1

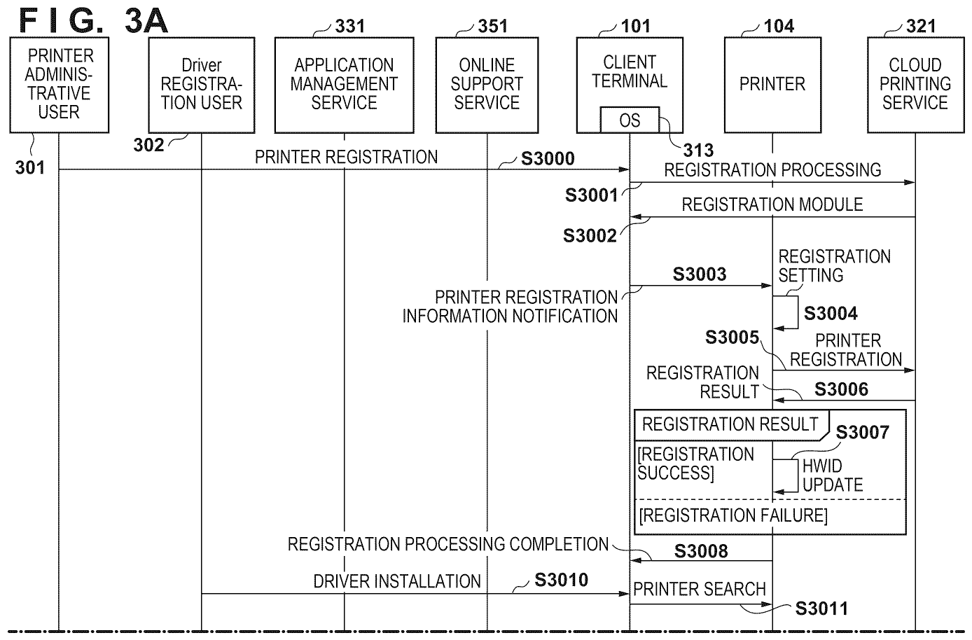

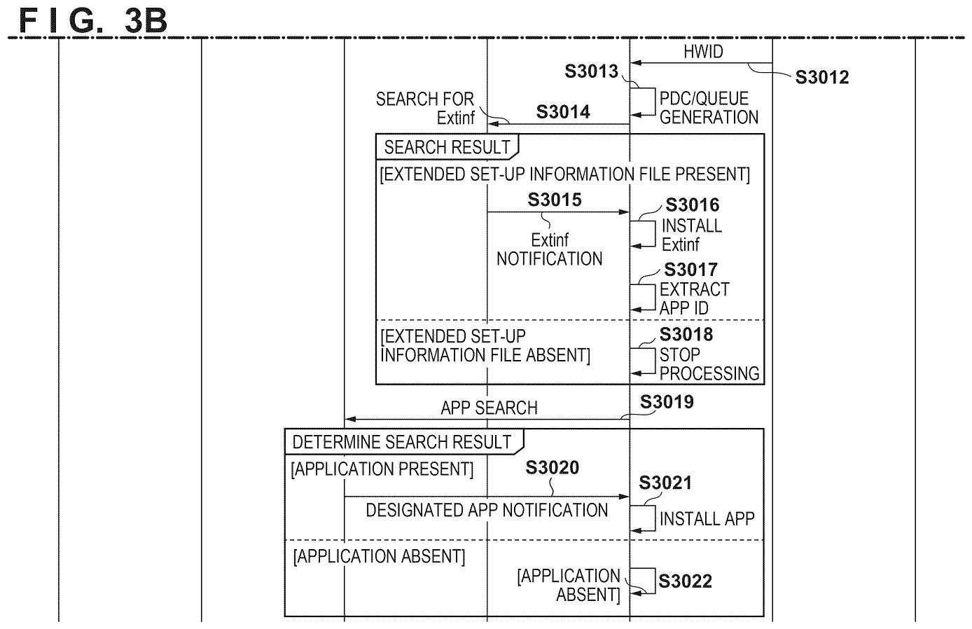

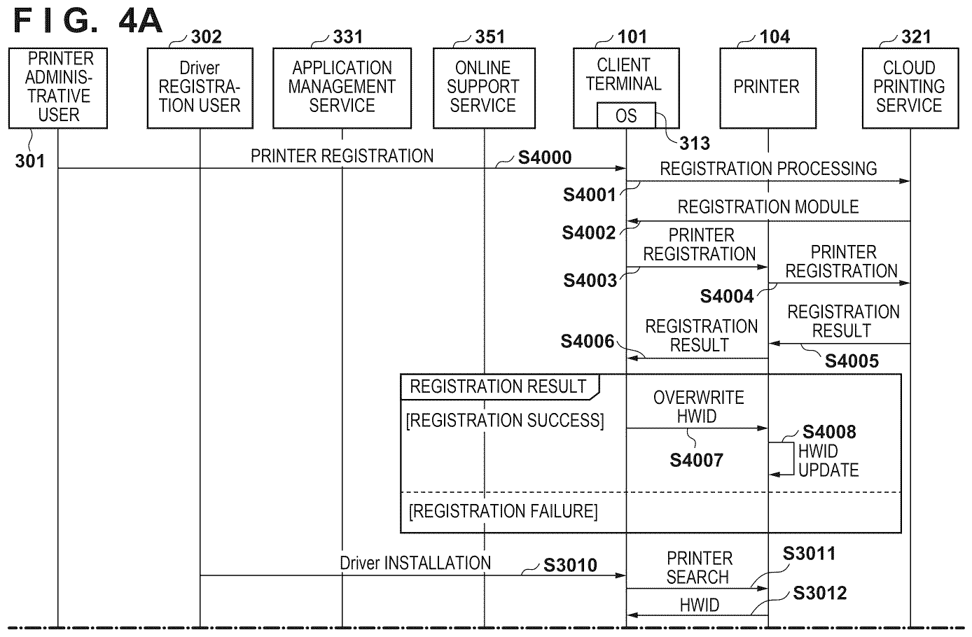

Next, an example of sequence processing of the image forming system 100 will be described with reference to FIGS. 3A and 3B. This processing is processing of installing a print setting extension application into the client terminal 101. Note that such processing is realized by a processor of each apparatus constituting the image forming system 100 executing a program stored in a storage medium and controlling each component. Note that the steps described mainly with an operating system (OS) 313 are mainly executed by the CPU 212 of the client terminal 101 in the hardware configuration.

In S3000, the OS 313 of the client terminal 101 displays a printer registration screen on the display unit 246 of the client terminal 101. Then, on this registration screen, the user performs an input operation for registering the printer 104 into the cloud printing service 321 provided by the cloud printing system 102. Then, the OS 313 receives this input via the operation unit 247.

In S3001, the OS 313 transmits the information input in S3000 to the cloud printing service 321 using the network communication unit 215. In this manner, printer registration processing is executed. In S3002, the cloud printing service 321 receives a printer registration processing request transmitted from the client terminal 101. Then, the cloud printing service 321 replies a printer registration module to the client terminal 101.

In S3003, the OS 313 of the client terminal 101 receives a printer registration module. Then, the OS 313 transmits tenant registration information toward the printer 104 using the printer registration module. Note that for example, an IP address is used to specify a destination printer. The tenant registration information includes a user ID and URL information of the tenant.

In S3004, a CPU 242 of the printer 104 receives the tenant registration information using the network communication unit 245. Then, the CPU 242 executes registration setting processing of the printer 104. Note that an application for the printer registration processing is installed in the printer 104 in advance. Then, when the tenant registration information is received, the registration processing is executed in response to the reception. Note that the printer registration module received by the client terminal 101 in S3002 may transmit a registration processing application to the printer 104, and the registration setting may be executed by the application being executed in the printer 104.

In S3005, using the network communication unit 245, the CPU 242 of the printer 104 accesses the tenant with the tenant URL received in S3003. Then, the CPU 242 transmits, toward the cloud printing system 102, tenant registration information, identification information (e.g., a MAC address of the printer) of the printer 104 in the cloud printing service 321, and a registration request. In S3006, the CPU 242 of the printer 104 receives a registration result of the printer 104 from the cloud printing system 102 (an example of an “external apparatus”) using the network communication unit 245 (an example of a “first communication unit that can communicate with an external apparatus”). Note that S3006 is an example of a “connecting and receiving”.

In S3007, the CPU 242 (an example of a “setting”) determines whether or not the registration is successful. Then, if the registration is successful, the CPU 242 automatically updates a Hardware Identification (HWID) of the printer 104. On the other hand, if the registration is not successful, the CPU 242 does not update the HWID. The HWID is an example of “identification information that can identify an image forming apparatus”. S3007 is an example of a “setting”. The updated HWID is an example of “identification information for a cloud printing service”. Then, in S3008, the CPU 242 transmits the completion of the registration processing toward the client terminal 101 using the network communication unit 245. Thereafter, the processing proceeds to S3010.

In S3010, the OS 313 of the client terminal 101 installs a printer driver by processing the input operation of a user 302. In S3011, the OS 313 searches for a printer connected to the network 107 in response to the input operation of the user 302. Note that the description will be given on an assumption that a printer registered in the cloud printing service 321 is searched for in the present sequence.

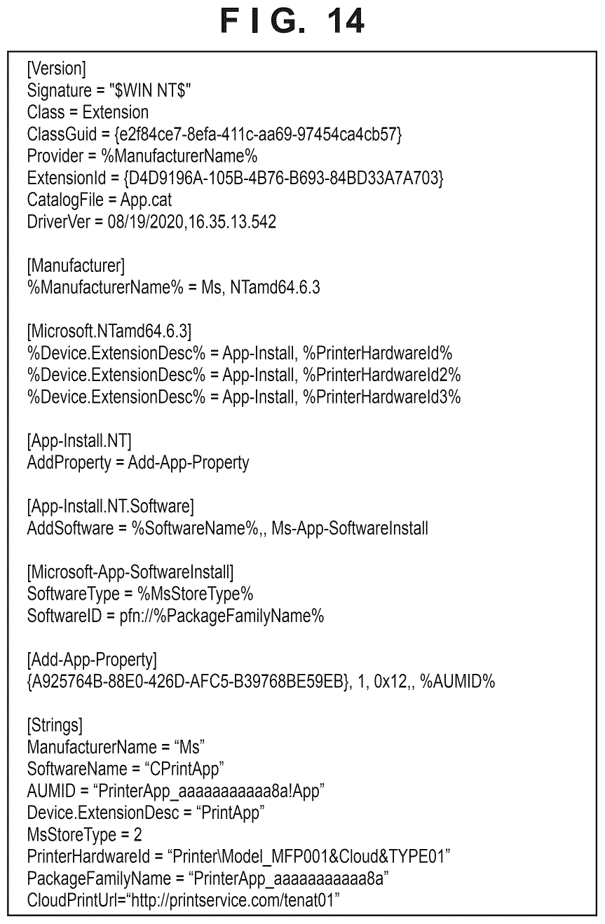

In S3012, if registered in the cloud printing service 321, the CPU 242 of the printer 104 transmits the HWID updated in S3007 toward the client terminal 101. The OS 313 of the client terminal 101 receives the updated HWID for the cloud printing service from this printer 104. The HWID is a character string, for example, PrinterHardwareId=‘Printer\Model_MFP001&Cloud&TYPE01’ described in FIG. 14. Note that S3012 is an example of a “transmiting” and a “receiving”.

In S3013, the OS 313 generates a print queue of the cloud printer driver 311 including basic print capability information bundled in the OS 313. Then, the OS 313 starts install processing of an application that extends the cloud printer driver 311 in association with the printer.

In S3014, the OS 313 transmits a search request for the extended set-up information file including the HWID updated for the cloud printing service to the online support service 351 provided at the online support server 106. Note that details of the extended set-up information file will be described later. The online support service 351 stores the extended set-up information file.

The extended set-up information file will be described with reference to FIG. 14. The extended set-up information file is a file created by a cloud printing service provider or a vendor of the printer 104 and registered in the online support service 351. The extended set-up information file describes an application identifier for specifying the print setting extension app. The item “PackageFamilyName” in FIG. 14 is identification information (application ID) of the print setting extension app. In the extended set-up information file, the printer HWID is described in the item “PrinterHardwareID”. That is, the extended set-up information file describes information that associates the printer HWID with the print setting extension app corresponding to this printer.

The description returns to the processing flow of FIGS. 3A and 3B. In S3015, the online support service 351 determines whether or not an extended set-up information file describing the HWID designated in the search request of S3014 exists. Then, if determining that the corresponding extended set-up information file exists, the online support service 351 replies the extended set-up information file to the client terminal 101, and the processing proceeds to S3016. On the other hand, if not, the online support service 351 replies an error notification to the client terminal 101, and the processing proceeds to S3018.

In S3016, the OS 313 installs, in association with the print queue generated in S3013, extended set-up information described in the extended set-up information file acquired from the online support service 351. In S3017, the OS 313 extracts the application ID from the installed extended set-up information.

In S3018, the OS 313 receives the error notification from the online support service 351, and completes the install of the cloud printer driver started in S3010. On the other hand, the OS 313 stops the install processing of the application that extends the cloud printer driver 311. Note that the OS 313 executes the processing of S3018 also in a case of having failed to receive the extended set-up information file within a predetermined time from the start of the search request of S3014.

S3019 and thereafter are a processing flow in a case where the extended set-up information file has been successfully acquired and the application ID has been successfully extracted in S3016. In S3019, the OS 313 requests the application management service 331 provided by the application management server 105 to search for an application matching the extracted application ID. Note that the application management service 331 stores in advance an application operating on the client terminal 101 and an application ID of the application in association with each other. The application and the application ID are registered in advance in the application management service 331 by the vendor that provides the cloud printing service 321 and the printer 104.

In S3020, the application management service 331 determines whether or not there is the print setting extension app 312 that matches the requested application ID. If determining that there is the print setting extension app 312, the application management service 331 replies the print setting extension app 312 to the client terminal 101. Then, in the client terminal 101, OS 313 receives this print setting extension app 312. Note that S3020 is an example of an “receiving”. Then, the processing proceeds to S3021. On the other hand, if not, the processing proceeds to S3022.

In S3021, the OS 313 installs the acquired print setting extension app 312 in association with the print queue on the client side (an example of an “image formation setting for a cloud printing service”). Note that S3021 is an example of a “performing the image formation setting”. On the other hand, in S3022, the OS 313 stops the install processing of the application. In this case, the generated print queue and the cloud printer driver 311 are installed in association with each other, but the print setting extension app 312 is not associated with the print queue. Thereafter, the processing ends.

As described above, in Processing Example 1, when the printer 104 receives a notification of successful registration to the cloud printing service from the cloud printing service 321, the HWID of the printer 104 is automatically updated.

### Processing Example 2

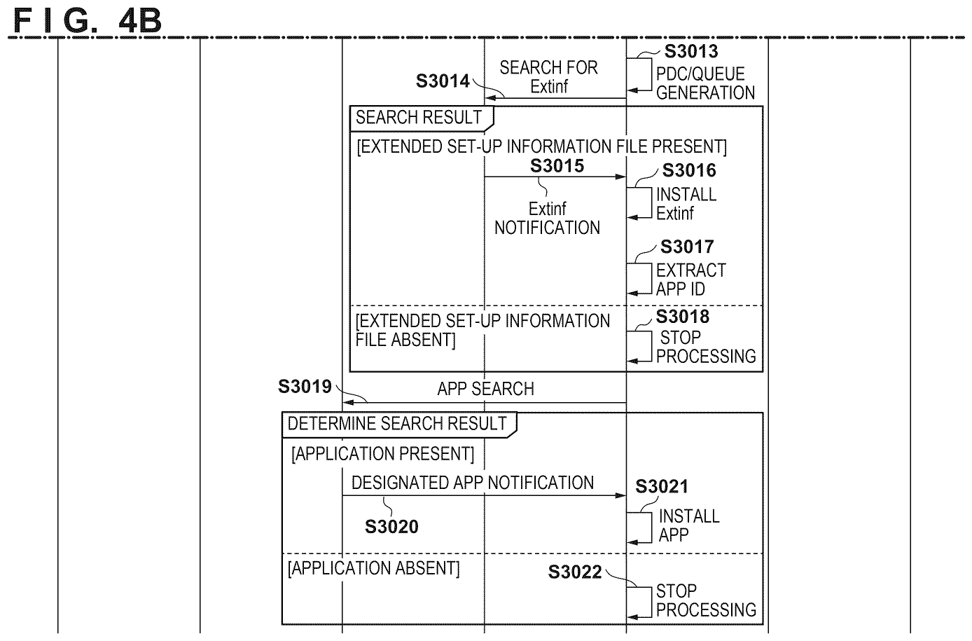

Next, another example of the sequence processing of the image forming system 100 related to FIGS. 3A and 3B will be described with reference to FIGS. 4A and 4B. In this processing flow, update of the HWID is manually executed by the user. Hereinafter, description will be given with steps S3001 to S3008 being replaced with steps S4001 to S4009. Note that such processing is realized by the CPU 212 loading, into the memory 213, a program stored in the storage unit 214 and controlling each component.

S4000 to S4003 are similar to S3000 to S3003, and thus description thereof will be omitted. In S4004, the CPU 242 of the printer 104 accesses the tenant URL notified in S4003, and registers the identification information (e.g., a printer body ID, a MAC address, or the like) of the printer 104. In this manner, the CPU 242 registers the printer 104 into the cloud printing service 321.

In S4005, the cloud printing service 321 replies the registration result to the printer 104. In S4006, the CPU 242 of the printer 104 receives the registration result using the network communication unit 245. The CPU 242 transmits the registration result toward the client terminal 101. In the client terminal 101, the OS 313 receives the registration result and determines whether or not the registration has been successful. Then, if the OS 313 determines that the registration has been successful, the processing proceeds to S4007. On the other hand, if not, the processing proceeds from S3010 to S3022, and then ends.

In S4007, the OS 313 of the client terminal 101 receives a user's input operation for remote login to the printer 104. The OS 313 then establishes a connection with the printer 104. The OS 313 receives a user input of HWID information of the printer 104 in a state where the connection is established. Then, the OS 313 transmits this HWID information to the printer 104.

In S4008, the CPU 242 of the printer 104 receives the HWID information from the client terminal 101 using the network communication unit 245. Then, the CPU 242 updates the HWID with the HWID received from the client terminal 101. More specifically, the original HWID registered in the printer is assumed to be Printerhardwareid=‘Printer\Model_MFP001’. Then, when the CPU 242 receives the attribute (Cloud) of the cloud printer and the attribute (TYPE01) of the tenant, the CPU 242 rewrites the HWID as follows. That is, Printerhardwareid=‘Printer\Model_MFP001&Cloud&TYPE01’. In this manner, manual update of the HWID by the user is realized. Thereafter, the processing proceeds from S3010 to S3022 and ends.

### Processing Example 3

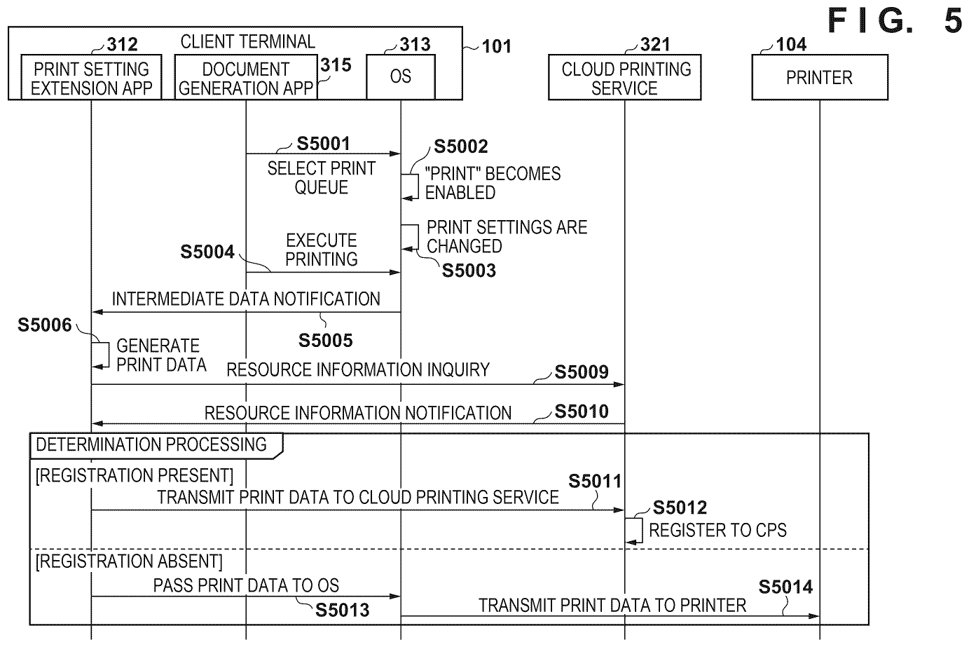

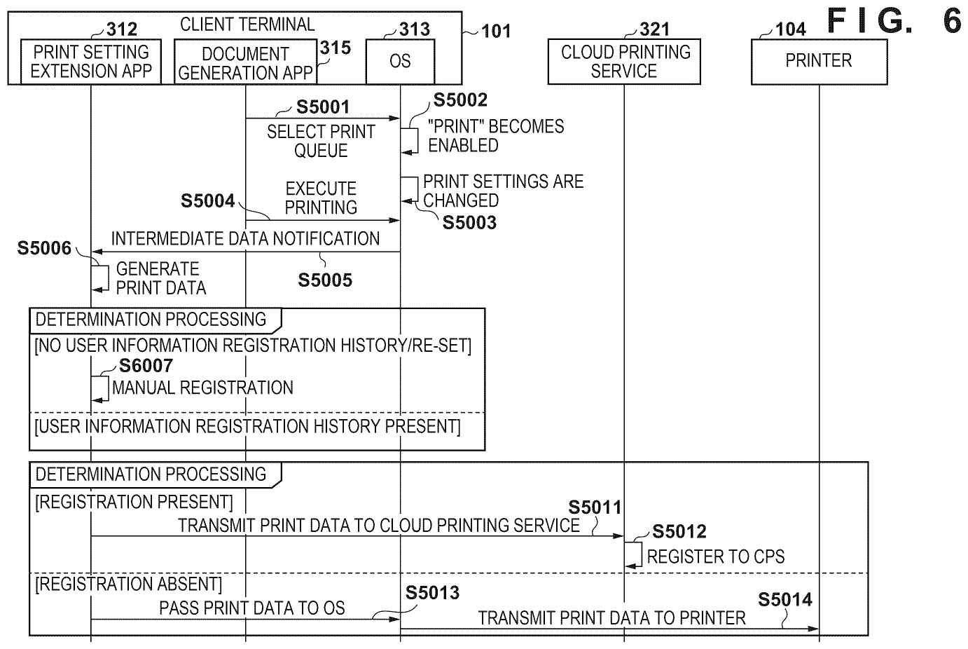

Next, an example of the sequence processing of the image forming system 100 will be described with reference to FIG. 5. This processing indicates an image forming procedure using the client terminal 101. Note that such processing is realized by the processor of each apparatus constituting the image forming system 100 executing a program stored in the storage medium and controlling each component.

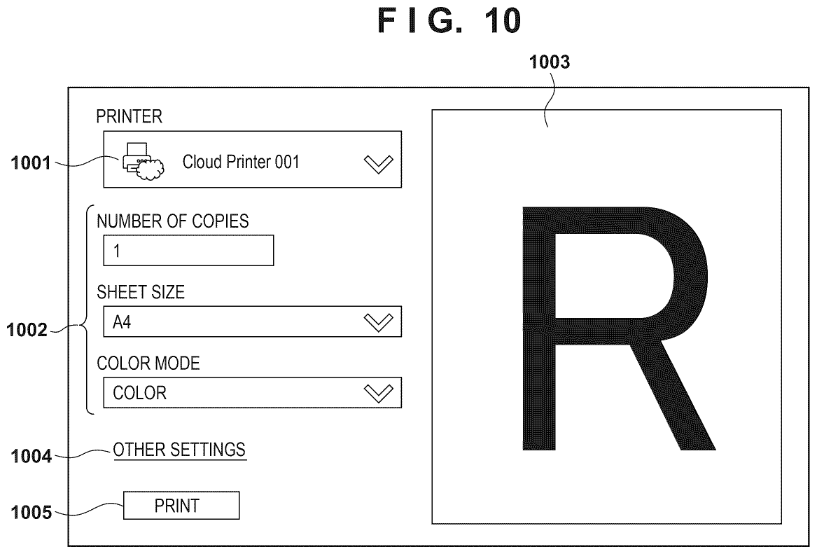

In S5001, the document generation app 315 of the client terminal 101 displays, on the display unit 216, a print setting screen (e.g., FIG. 10) on which a print queue selection operation can be performed. Note that the OS 313 may display a similar screen. As illustrated in FIG. 10, the print setting screen displays an object 1001 for selecting a print queue, an object 1002 for performing various print settings, a print preview image 1003, and an object 1004 for performing other settings. The OS 313 selects a print queue associated with the printer set as a default printer. Note that a printer registered in the cloud printing service 321, for example, is set as the default printer.

In S5002, the OS 313 enables an object serving as a trigger for displaying an UI of the print setting extension app 312 of the OS 313. In S5003, the print setting extension app 312 displays a print setting UI on the display unit 216. Then, the print setting extension app 312 receives an operation on an object for an extension setting displayed on the print setting UI. By such an operation, the print setting is changed (an example of an “image formation setting for a cloud printing service”). In S5004, the document generation app 315 receives a selection operation of an object 1005 (FIG. 10) displayed on the print setting screen. Then, the OS 313 executes print processing based on the print instruction input via the document generation app 315.

In S5005, the OS 313 receives an instruction for the print execution and generates intermediate data. Then, the OS 313 passes the generated intermediate data and the print setting information to the print setting extension app 312. Note that the intermediate data is data generated before being converted into print data such as page description language (PDL), and includes, for example, XML paper specification (XPS) data.

In S5006, the print setting extension app 312 acquires the intermediate data from the OS 313. Then, the print setting extension app 312 generates print data based on the intermediate data. Thereafter, the processing proceeds to S5009. In S5009, the print setting extension app 312 accesses the tenant URL (CloudPrintUrl) of the cloud printing service 321 to be described in the extended set-up information file (see FIG. 14) managed by the OS 313. Then, the print setting extension app 312 makes an inquiry for resource information of the cloud printing service 321.

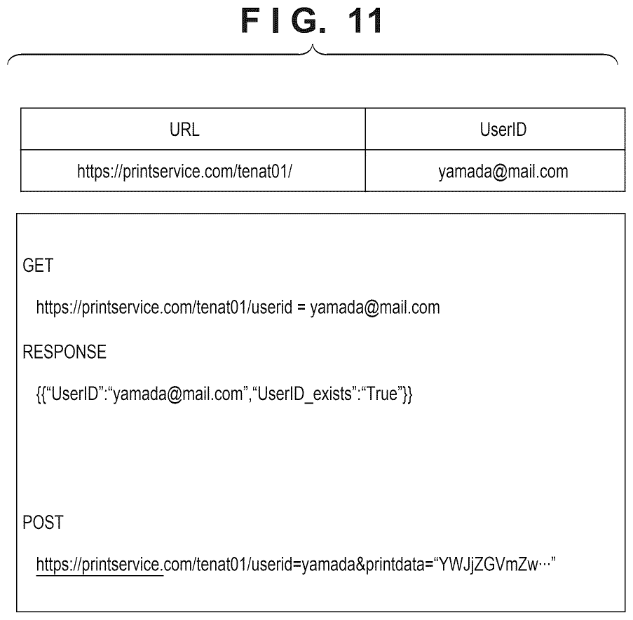

An REST API used for the inquiry for the resource information with respect to the cloud printing service 321 will be described with reference to FIG. 11. Note that REST API is an abbreviation for Representational State Transfer Application Programming Interface. A character string in which the tenant URL and the registration information registered in the cloud printing service 321 are combined is used for the inquiry for the resource information of the cloud printing service 321. The registration information registered in the cloud printing service 321 includes login user information (e.g., yamada@mail.com as a login ID) of the OS 313, for example. Note that the user registration information is not limited to the login ID as long as the user can be identified. Then, the print setting extension app 312 executes a GET request command including this character string.

In S5010, the cloud printing service 321 of the cloud printing system 102 receives a GET request. The cloud printing service 321 then collates the login ID included in the request with the user ID stored in a memory 223. Thereafter, as a response to the GET request, the cloud printing service 321 transmits, toward the client terminal 101, a character string including information indicating whether or not the user registration has been performed in the cloud printing service 321 and the resource information. If the user registration has been performed in the cloud printing service 321, the character string is, for example, “UserID_exists”:“True” (see FIG. 11). Then, the print setting extension app 312 of the client terminal 101 receives this response. Then, using such a response, the print setting extension app 312 (an example of a “determination unit”) determines whether or not the user registration has been performed in the cloud printing service 321. For example, if “UserID_exists”:“True” is included in the response, the print setting extension app 312 determines that the user registration has been performed in the cloud printing service 321, and the processing proceeds to S5011. On the other hand, if not, the processing proceeds to S5013.

In S5011, the print setting extension app 312 transmits, using the REST API, the print data (an example of “image formation data”) generated in S5006 to the cloud printing service 321 or the printer 104. The REST API for transmitting print data will be described with reference to FIG. 11. A character string in which the tenant URL, the registration information, and the file name of the print data are combined is used for transmission of the print data. Then, the print setting extension app 312 executes a POST request command including this character string. In this manner, when it is confirmed that the user has been registered in the cloud printing service 321, a print job is transmitted to the cloud printing service 321. Then, in S5012, the cloud printing service 321 receives this POST request, and causes the memory 223 of the cloud printing system 102 to store the print data. Then, this print data is output in response to a print request from the printer 104. The printer 104 receives and prints this print data. Then, the processing ends.

On the other hand, if determining that the printer 104 has not been registered in the cloud printing service 321 in S5010, the print setting extension app 312 in S5013 passes the print data to the OS 313. The OS 313 stores this print data in a print queue. In S5014, the OS 313 transmits this print data to the printer 104. Then, the printer 104 prints this print data. Then, the processing ends.

As described above, Processing Example 3 queries the cloud printing service 321 for the resource information. Then, if the printer 104 has been registered in the cloud printing service, the print data is transmitted to the cloud printing service 321, and otherwise, the print data is transmitted to the printer 104.

### Processing Example 4

In Processing Example 3, in S5009 and S5010, the print setting extension app 312 acquires the resource information from the cloud printing service 321 and determines the registration status of the printer 104. However, the registration status may be determined without querying the cloud printing service 321. That is, in Processing Example 4, the memory 213 of the client terminal 101 is caused to store the user account that has registered the printer 104 into the cloud printing service, and the presence or absence of registration is determined depending on the presence or absence of this user account. Note that such processing is realized by the processor of each apparatus constituting the image forming system 100 executing a program stored in the storage medium and controlling each component.

First, similarly to Processing Example 3, S5001 to S5006 are executed. Thereafter, when the printer driver is used, the print setting extension app 312 of the client terminal 101 determines the presence or absence of a history of a user registration setting for using the cloud printing service. Then, if there is the history of the user registration setting, the print setting extension app 312 assumes that the printer 104 has been registered in the cloud printing service 321, and the processing proceeds to S5011, and otherwise, the processing proceeds to S6007.

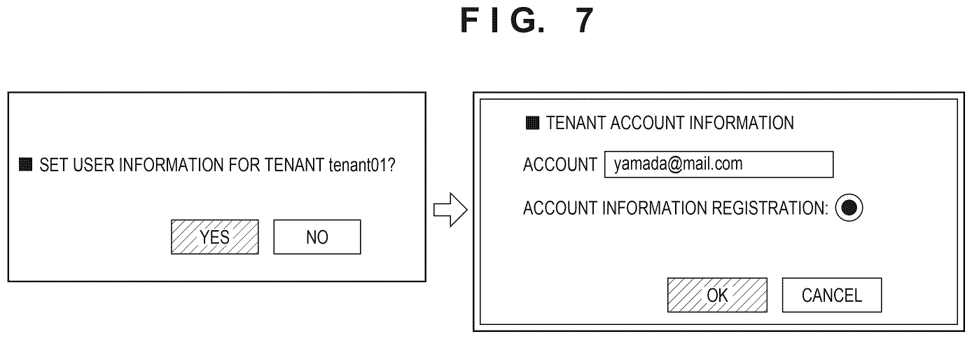

In S6007, the print setting extension app 312 displays a setting UI on the display unit 216. This setting UI will be described with reference to FIG. 7. The setting UI includes a screen prompting registration of account information. In a case of a user who has registered the printer 104 into the cloud printing service 321, the user touches a “YES” icon displayed on the UI. Then, the print setting extension app 312 (an example of a “reception unit”) receives this operation and causes the display screen to transition to a screen on which the account information can be input. Then, the user inputs, for example, an e-mail address as registration information. A check is input in a field of registration of the account information. Then, the print setting extension app 312 receives these operations and determines that the printer 104 has been registered in the cloud printing service 321, and the processing proceeds to S5011.

On the other hand, if the user has not registered the printer 104 into the cloud printing service 321, the user touches a “NO” icon displayed on the UI. Then, the print setting extension app 312 receives this operation and determines that the printer 104 has not been registered in the cloud printing service 321, and the processing proceeds to S5013. Note that the processing from S5011 to S5014 is similar to the processing in Processing Example 3. Then, the processing ends. In this manner, Processing Example 4 can determine the registration status of the printer 104 without querying the cloud printing service 321.

### One Aspect of Actions and Effects

According to the image forming system 100 as described above, the HWID of the printer 104 is updated in response to registration of the printer 104 into the cloud printing service 321. Then, the print setting extension app 312 for the cloud printing service can be acquired using this updated HWID (S3016 to S3020). Therefore, the print setting for the cloud printing service can be easily introduced.

### Second Embodiment

In the processing flow of FIGS. 3A and 3B according to the first embodiment, the HWID of the printer 104 has already been updated (S3007) at the time point of installing the printer driver into the client terminal 101 (S3010). Therefore, the cloud printing compatible driver is always installed. Therefore, in a case where the user who has installed the printer driver has not registered the printer 104 into the cloud printing service 321, tenant unregistration processing is needed in order to install a cloud printing incompatible driver as a printer driver. Therefore, in the second embodiment, it is determined whether or not the user who operates the client terminal 101 is a user who has registered the printer 104 into the cloud printing service 321. Then, the original HWID and the HWID for cloud printing are switched depending on the determination result.

### Processing Example 5

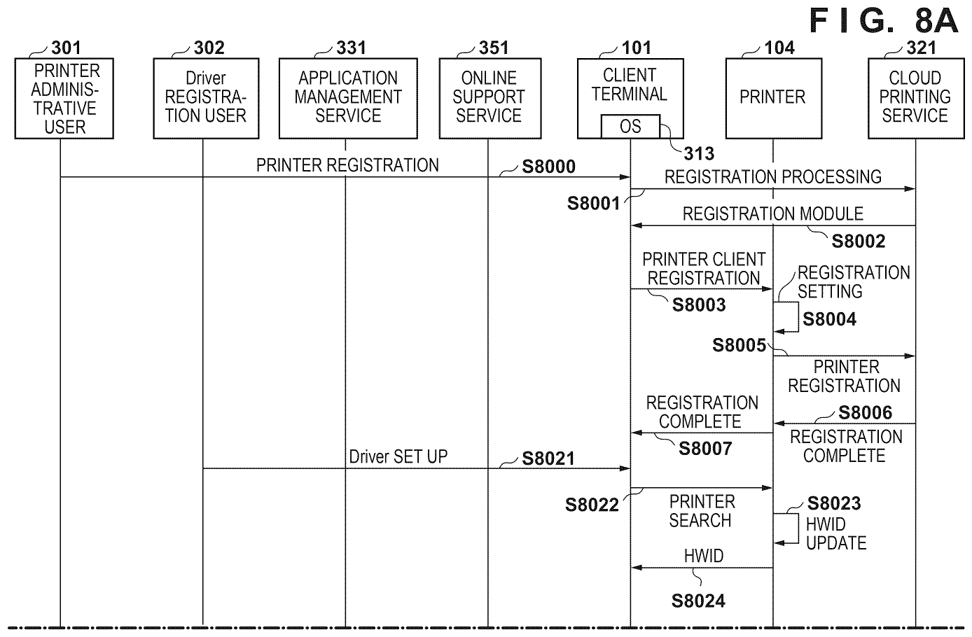

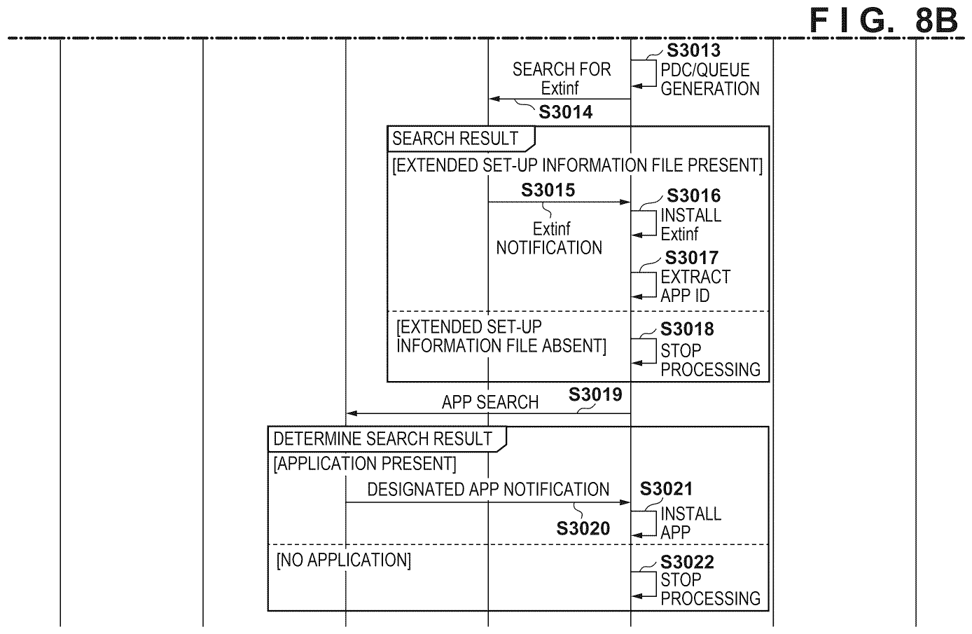

An example of the sequence processing of the image forming system 100 according to the second embodiment will be described with reference to FIGS. 8A and 8B. This processing is another example of the processing of installing a print setting extension application into the client terminal 101. Note that such processing is realized by the processor of each apparatus constituting the image forming system 100 executing a program stored in the storage medium and controlling each component.

The processing of S8001 to S8006 is similar to that of S3001 to S3006 of Processing Example 1 according to the first embodiment, and thus description thereof will be omitted. In S8007, the CPU 242 of the printer 104 transmits, toward the client terminal 101, the registration result of the printer 104 received in S8006. Note that the registration result is assumed to be registration completion. Then, the processing proceeds to S8021.

In S8021, the OS 313 of the client terminal 101 installs the printer driver by processing the input operation of the user 302. In S8022, the OS 313 searches for the registered printer 104 connected to the network 107 in response to the input operation of the user 302. More specifically, the OS 313 transmits packet information including identification information of the user 302 to the registered printer 104.

In S8023, the CPU 242 of the printer 104 acquires search packet information transmitted from the client terminal 101 using the network communication unit 245. Then, the CPU 242 determines whether or not the identification information of the user 302 included in the packet information is of the user who has registered the printer 104 into the cloud printing service 321. If determining as the user who has registered the printer 104, the CPU 242 newly generates an HWID for the cloud printing service, and switches the HWID of the printer 104 to this HWID for the cloud printing service.

Note that the identification information of the user 302 is, for example, “yamada@mail.com”, which is the user login ID of the OS 313, and is stored in a memory 243 as tenant registration information at the time of registration of the printer 104. The content of the identification information of the user 302 included in the search packet of the printer and the registration information of the cloud printing service 321 are not limited as long as they are information (user identification information) that can specify a client terminal 401. For example, the MAC address of the client terminal 401 may be registered in the printer 104.

In S8024, the CPU 242 transmits the HWID toward the client terminal 101. If a new HWID is generated in S8023, the HWID to be transmitted is the new HWID, and if not generated, the HWID to be transmitted is the original HWID. If the user who operates the client terminal 101 in this manner is the user who has registered the printer 104 into the cloud printing service 321, the HWID to be notified toward the client terminal 101 is switched. Thereafter, the processing proceeds from S3014 to S3022. Note that S3014 to S3022 are similar to S3014 to S3022 of Processing Example 1 according to the first embodiment, and thus description thereof will be omitted. Then, the processing ends.

### Processing Example 6

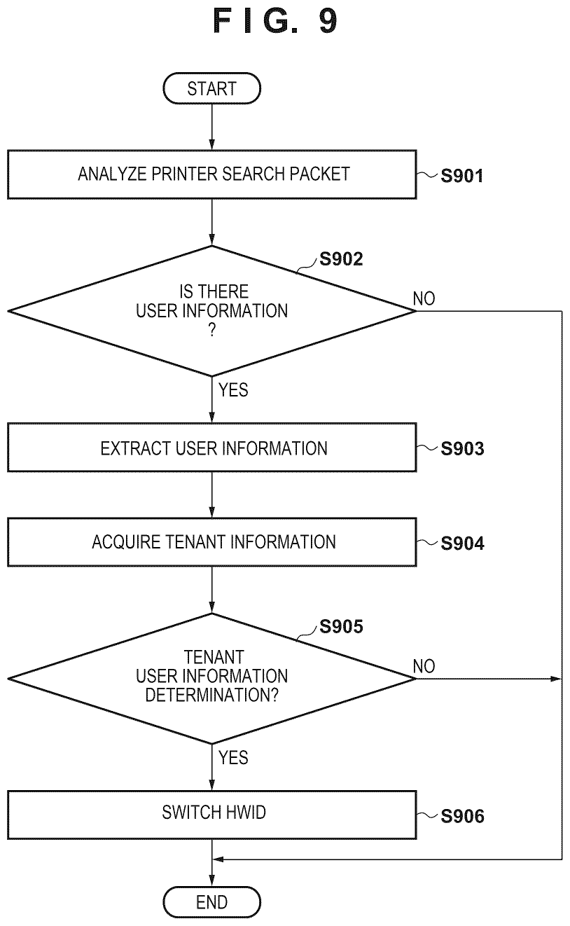

Details of the HWID switching processing in S8023 will be described with reference to FIG. 9. Note that such processing is realized by the CPU 242 of the printer 104 executing a program stored in the memory 243 and controlling each component.

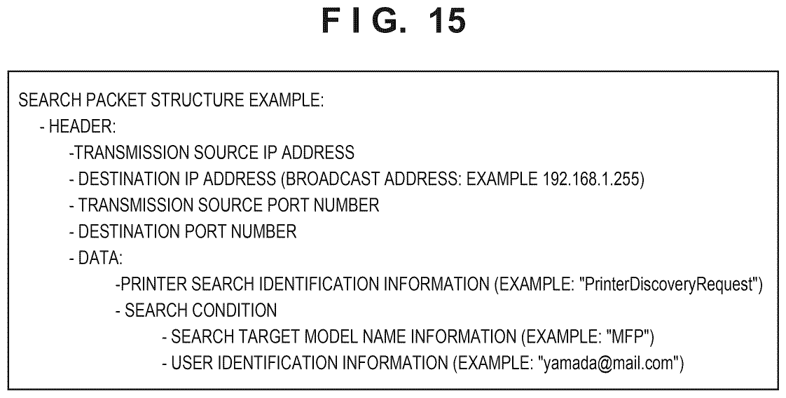

In S901, the CPU 242 acquires a search packet from the client terminal 101 using the network communication unit 245, and analyzes the packet. FIG. 15 illustrates a data structure of a search packet. The search packet includes, for example, a source/destination IP address, a source/destination port number, as well as printer search identification information as data, and a search condition. Note that here, the user identification information is a user login ID.

In S902, the CPU 242 determines whether or not the user identification information is included in the search packet. If the CPU 242 determines that the user identification information is “present”, the processing proceeds to S903, and otherwise, the processing ends with the user identification information being “absent”.

In S903, the CPU 242 extracts the user identification information from the search packet. In S904, the CPU 242 acquires the tenant information from the cloud printing service 321 using the network communication unit 245. In S905, the CPU 242 determines whether or not the user identification information extracted in S903 exists in the tenant information acquired in S904. Then, if the CPU 242 determines that the user identification information is “present”, the processing proceeds to S906, and otherwise, the processing ends.

In S906, the CPU 242 generates a new HWID. More specifically, it is assumed that the original HWID is PrinterHardwareId=“Printer\Model_MFP001”. Then, it is assumed that the attribute of the cloud printer is “Cloud” and the attribute of the tenant is “TYPE01”. In such a case, these attributes are added to the original HWID and a new HWID with PrinterHardwareId=“Printer\Model_MFP001&Cloud&TYPE01” is generated. Then, the HWID of the printer 104 is switched to the new HWID. Then, the processing ends. In this manner, the HWID switching processing in S8023 is executed.

### Processing Example 7

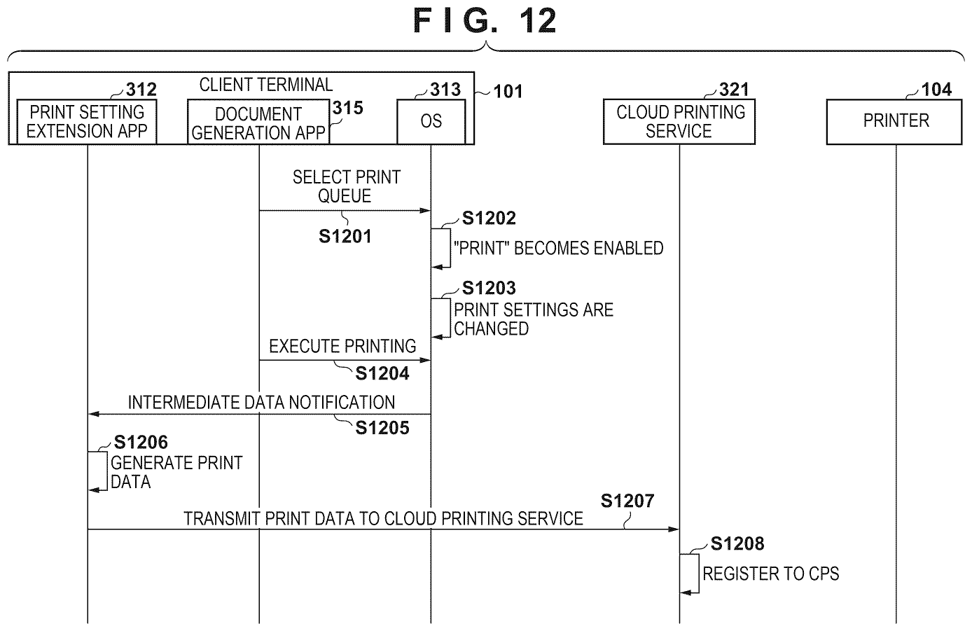

An example of the sequence processing of the image forming system 100 according to the second embodiment will be described with reference to FIG. 12. This processing indicates another example of the image forming procedure using the client terminal 101. Note that such processing is realized by the processor of each apparatus constituting the image forming system 100 executing a program stored in the storage medium and controlling each component. Note that the present processing is a flow in a case where the new HWID for the cloud printing service is notified from the printer 104 toward the client terminal 101 in S8023 and S8024, and a driver is set up with the new HWID.

S1201 to S1206 are similar to S5001 to S5006 of Processing Example 3 according to the first embodiment, and thus description thereof will be omitted. Note that in the present sequence, it is assumed that a printer (printer driver) corresponding to the HWID notified in S8024 in Processing Example 6 is selected as a default printer. Then, the processing proceeds to S1207.

In S1207, the print setting extension app 312 transmits the print data generated in S1206 to the cloud printing service 321 using the REST API (FIG. 11). Then, in S1208, the cloud printing service 321 receives the POST request, and causes the memory 223 of the cloud printing system 102 to store the print data. The print data stored in the memory 223 is transmitted to the printer 104 triggered by the user selecting and operating the job on the display unit 246 of the printer 104. Then, the print data is printed by the printer 104 (pull print printing). Then, the processing ends. When the new HWID for the cloud printing service is notified from the printer 104 toward the client terminal 101 in this manner, the print data is transmitted toward the cloud printing service 321.

### Processing Example 8

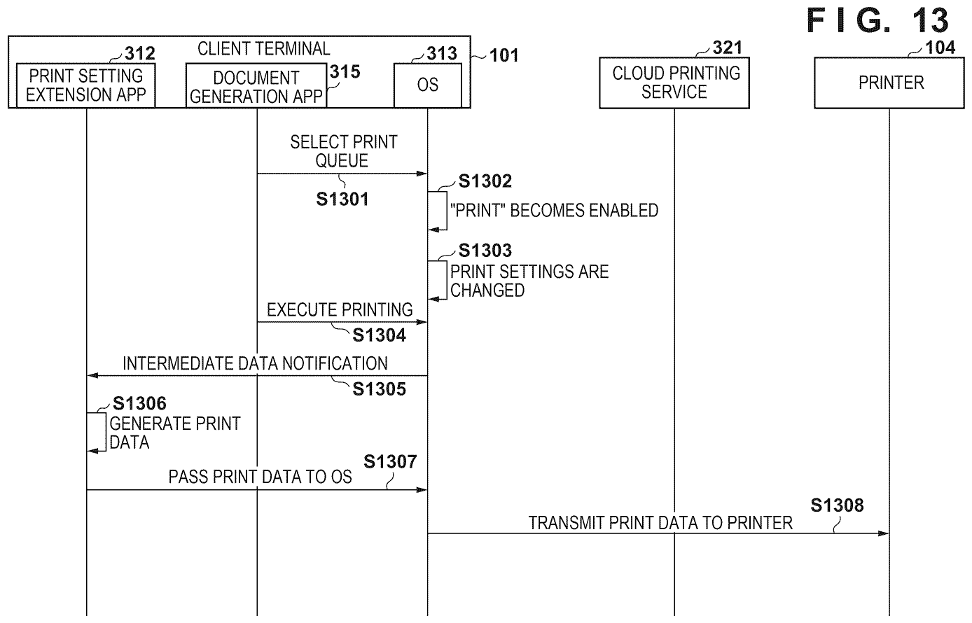

An example of the sequence processing of the image forming system 100 according to the second embodiment will be described with reference to FIG. 13. This processing indicates another example of the image forming procedure using the client terminal 101. Note that such processing is realized by the processor of each apparatus constituting the image forming system 100 executing a program stored in the storage medium and controlling each component. Note that the present processing is a flow in a case where the original HWID is notified from the printer 104 toward the client terminal 101 in S8024. By executing such a flow, the print data is not uploaded to the cloud printing system 102, and printing is directly executed by the printer 104.

S1301 to S1306 are the same flow as S1201 to S1206, and thus description thereof will be omitted. In S1307, the print setting extension app 312 passes the print data to the OS 313. The OS 313 stores this print data into the print queue. In S1308, the OS 313 transmits this print data to the printer 104. The printer 104 receives this print data and executes the print processing. Then, the processing ends. When the original HWID is notified from the printer 104 toward the client terminal 101 in this manner, the print data is transmitted toward the printer 104.

### One Aspect of Actions and Effects

According to the image forming system 100 according to the second embodiment, in a case where the user who has installed the printer driver is the user who has registered the printer 104 into the cloud printing service 321, effects similar to those of the image forming system 100 according to the first embodiment are obtained. In addition, in a case where the user who has installed the printer driver is not the user who has registered the printer 104 into the cloud printing service 321, the print setting extension app 312 for the cloud printing service is not installed (S3018 and S3022). Therefore, the user can install a cloud printing incompatible driver as a printer driver without performing the tenant unregistration processing. Therefore, user convenience is improved.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-192412, filed Oct. 31, 2024, which is hereby incorporated by reference herein in its entirety.

What is claimed is:

1. An image forming apparatus that can communicate with a cloud printing system that provides a cloud printing service, the image forming apparatus comprising:
one or more first memory devices that store a set of instructions; and
one or more first processors that execute the set of instructions to:
connect to a communication network, and
set identification information that can identify the image forming apparatus, wherein
when first information indicating that the image forming apparatus has been registered in the cloud printing service is received,
identification information for the cloud printing service for performing an image formation setting for the cloud printing service is set as identification information of the image forming apparatus, and
the identification information for the cloud printing service having been set is transmitted toward an information processing terminal.

2. The image forming apparatus according to claim 1, wherein
the one or more first processors execute instructions in the one or more first memory devices to:
transmit, toward the cloud printing system, information indicating a registration request of the image forming apparatus to the cloud printing service,
receive the first information from the cloud printing system, and
set the identification information for the cloud printing service to identification information of the image forming apparatus in response to reception of the first information from the cloud printing system.

3. The image forming apparatus according to claim 1, wherein
the one or more first processors execute instructions in the one or more first memory devices to:
transmit the first information toward the information processing terminal in response to reception of the first information,
receive the identification information for the cloud printing service from the information processing terminal, and
set the identification information for the cloud printing service to identification information of the image forming apparatus in response to reception of the identification information for the cloud printing service from the information processing terminal.

4. The image forming apparatus according to claim 1, wherein
the one or more first processors execute instructions in the one or more first memory devices to:
switch the identification information of the image forming apparatus from original identification information to the identification information for the cloud printing service in response to reception of a search for the image forming apparatus connected to the cloud printing system from the information processing terminal.

5. The image forming apparatus according to claim 2, wherein
the one or more first processors execute instructions in the one or more first memory devices to:
transmit the identification information for the cloud printing service toward the information processing terminal in response to reception of a search for the image forming apparatus connected to the cloud printing system from the information processing terminal.

6. An image forming system comprising:
the image forming apparatus according to claim 1; and
the information processing terminal, wherein
the information processing terminal includes
one or more second memory devices that store a set of instructions, and
one or more second processors that execute the set of instructions in the second memory device to:
connect to a communication network, and
set the image formation setting for the cloud printing service, and wherein
the one or more second processors execute instructions in the one or more second memory devices to:
receive the identification information for the cloud printing service transmitted from the image forming apparatus,
receive an application for performing an image formation setting for the cloud printing service by using the identification information for the cloud printing service, and
perform the image formation setting for the cloud printing service by using the application.

7. The image forming system according to claim 6, wherein
the one or more second processors execute instructions in the one or more second memory devices of the information processing terminal to:
further determine whether or not to use the cloud printing service based on registration information of the image forming apparatus to the cloud printing service,
transmit image formation data toward the cloud printing system if determining to use the cloud printing service, and
transmit the image formation data toward the image forming apparatus if determining not to use the cloud printing service.

8. The image forming system according to claim 7, wherein
the one or more second processors execute instructions in the one or more second memory devices of the information processing terminal to:
receive the registration information from the cloud printing system, and
perform the determination based on the registration information having been received.

9. The image forming system according to claim 7, wherein
the one or more second processors execute instructions in the one or more second memory devices of the information processing terminal to:
accept an input operation of the registration information, and
perform the determination based on the registration information having been accepted.

10. The image forming system according to claim 7, wherein
the registration information includes user information of a user who has registered the image forming apparatus into the cloud printing service.

11. A control method for an image forming system including an image forming apparatus that can communicate with a cloud printing system that provides a cloud printing service, and an information processing terminal, the control method comprising:
in the image forming apparatus,
connecting to a communication network and receiving information indicating that the image forming apparatus has been registered in the cloud printing service,
setting, as identification information of the image forming apparatus, identification information for the cloud printing service for performing an image formation setting for the cloud printing service, and
transmitting the identification information for the cloud printing service having been set toward the information processing terminal, and
in the information processing terminal,
receiving the identification information for the cloud printing service having been transmitted from the image forming apparatus,
receiving an application for performing the image formation setting for the cloud printing service by using the identification information for the cloud printing service, and
performing the image formation setting for the cloud printing service by using the application.

12. A non-transitory computer-readable storage medium storing a computer program for causing a computer to execute each step in a control method for an image forming apparatus that can communicate with a cloud printing system that provides a cloud printing service, the control method including
connecting to a communication network and receiving information indicating that the image forming apparatus has been registered in the cloud printing service,
setting, as identification information of the image forming apparatus, identification information for the cloud printing service for performing an image formation setting for the cloud printing service, and
transmitting the identification information for the cloud printing service having been set toward an information processing terminal.
